(19) United States
(12) Patent Application Publication
(10) Pub. No.: US 2025/0173546 A1
(43) Pub. Date: May 29, 2025

(54) METHOD AND APPARATUS OF COMPILING ARTIFICIAL NEURAL NETWORK

(71) Applicant: ELECTRONICS AND TELECOMMUNICATIONS RESEARCH INSTITUTE, Deajeon (KR)

(72) Inventors: Youngmok HA, Deajeon (KR); Yongjoo KIM, Deajeon (KR); Eunji PAK, Deajeon (KR)

(73) Assignee: ELECTRONICS AND TELECOMMUNICATIONS RESEARCH INSTITUTE, Daejeon (KR)

(21) Appl. No.: 18/795,306

(22) Filed: Aug. 6, 2024

(30) Foreign Application Priority Data
Nov. 23, 2023 (KR) 10-2023-0164179

(51) Int. Cl. G06N 3/042; G06N 3/047

(52) U.S. Cl. CPC G06N 3/042; G06N 3/047

(57) ABSTRACT

A method of compiling an artificial neural network includes partitioning a graph representing an artificial neural network into partial graphs, determining a partial partitioning space which has to be intensively searched for in a total partitioning space and then generating node information about nodes associated with the partial partitioning space, in a case which defines, as the total partitioning space, a set including the number of all cases corresponding to a partitioning method capable of being used in a process of partitioning the graph into the partial graphs, partitioning the graph into the partial graphs by using an optimal partitioning method selected by configuring and searching for the partial partitioning space, based on the node information, and generating artificial neural network intermediate representations, based on the partial graphs, and arranging the artificial neural network in different computing hardware resources based on the artificial neural network intermediate representations.

### CROSS-REFERENCE TO RELATED APPLICATIONS

This application claims the benefit of the Korean Patent Application No. 10-2023-0164179 filed on Nov. 23, 2023, which is hereby incorporated by reference as if fully set forth herein.

### BACKGROUND

### Field of the Invention

The present invention relates to technology for compiling an artificial neural network, and more particularly, to technology for obtaining intermediate representation in an artificial neural network compiler.

### Discussion of the Related Art

Artificial neural network compilers are technology which extracts, converts, generates, or provides information, needed for computing hardware equipping and driving, from an artificial neural network when an artificial neural network is equipped (disposed or loaded) in computing hardware configured with various logic chips (for example, central processing unit (CPU), graphics processing unit (GPU), neural processing unit (NPU), neural management unit (NMU), and processing in memory (PIM)) and learning or inference desired by the artificial neural network is to be performed.

Artificial neural network compilers derive, generate, or provide intermediate representation suitable for driving of computing hardware so as to extract, convert, generate, or provide information needed for equipping and driving of computing hardware, based on an artificial neural network characteristic and a computing hardware characteristic. Here, artificial neural network intermediate representation is defined as a data structure or code which is internally used by a compiler or a virtual machine so as to represent a source code representing an artificial neural network. An example of intermediate representation includes a computational graph.

In a process of deriving artificial neural network intermediate representation, artificial neural network compilers use search technology for searching for optimal intermediate representation in terms of resource use efficiency. Here, a resource denotes all resources which are considered to be a temporal and spatial resource, a power and electricity resource, a device resource (calculation, storage, connection information transfer, etc.), a profile or data resource when an artificial neural network is equipped in computing hardware and learning or inference desired by the artificial neural network is to be performed.

Recently, artificial neural network compilers are using machine learning-based search technology so as to search for optimal intermediate representation in terms of resource use efficiency. However, conventional artificial neural network compilers using machine learning-based search technology have a problem where a search space exponentially increases when a size of an artificial neural network increases, and due to this, it is unable to detect optimal intermediate representation in terms of resource use efficiency.

Moreover, conventional artificial neural network compilers using machine learning-based search technology have a problem where optimal intermediate representation is derived on only the use efficiency of a specific resource. That is, conventional technology has a problem where the use efficiencies of various kinds of resources are not simultaneously and complexly considered in a process of searching for optimal intermediate representation.

### SUMMARY

An aspect of the present invention is directed to providing a method and apparatus of compiling an artificial neural network, which may provide an artificial neural network intermediate representation capable of optimizing the amount of resource use of computing hardware in a process of equipping an artificial neural network in the computing hardware.

To achieve these and other advantages and in accordance with the purpose of the invention, as embodied and broadly described herein, there is provided a method of compiling an artificial neural network, the method including: a step of partitioning a graph representing an artificial neural network into partial graphs by using an artificial neural network partitioning module; a step of determining, by using a partitioning space minimization module, a partial partitioning space which has to be intensively searched for in a total partitioning space and then generating node information about nodes associated with the partial partitioning space, in a case which defines, as the total partitioning space, a set including the number of all cases corresponding to a partitioning method capable of being used in a process of partitioning the graph into the partial graphs; a step of partitioning, by using the artificial neural network partitioning module, the graph into the partial graphs by using an optimal partitioning method selected by configuring and searching for the partial partitioning space, based on the node information, and generating artificial neural network intermediate representations, based on the partial graphs; and a step of arranging the artificial neural network in different computing hardware resources by using an arrangement module, based on the artificial neural network intermediate representations.

It is to be understood that both the foregoing general description and the following detailed description of the present invention are exemplary and explanatory and are intended to provide further explanation of the invention as claimed.

### BRIEF DESCRIPTION OF THE DRAWINGS

FIG. 1 is a configuration diagram of a computing device including an artificial neural network compiler according to an embodiment of the present invention.

FIG. 2 is a configuration diagram illustrating an example of a partitioning space minimization module of FIG. 1.

FIG. 3 is a flowchart for describing a process of generating node information about nodes for participating in a partitioning space in nodes of each partial graph in the partitioning space minimization module of FIG. 2.

FIG. 4 is a flowchart for describing a method of compiling an artificial neural network according to an embodiment of the present invention.

### DETAILED DESCRIPTION OF THE INVENTION

Hereinafter, embodiments of the invention will be described in detail with reference to the accompanying drawings. In describing the invention, to facilitate the entire understanding of the invention, like numbers refer to like elements throughout the description of the figures, and a repetitive description on the same element is not provided.

In the following description, the technical terms are used only for explain a specific exemplary embodiment while not limiting the present invention. The terms of a singular form may include plural forms unless referred to the contrary. The meaning of ‘comprise’, ‘include’, or ‘have’ specifies a property, a region, a fixed number, a step, a process, an element and/or a component but does not exclude other properties, regions, fixed numbers, steps, processes, elements and/or components.

First, technical terms used herein for helping understand embodiments of the present invention will be briefly described.

### Artificial Neural Network

Herein, an artificial neural network may denote an artificial intelligence (AI) model which is designed and implemented by replicating a neural network of life. The artificial neural network may be called several names on the basis of the degree to which a biological characteristic is reflected in replicating a neural network of life, may be a bio-inspired or spiking artificial neural network in models in which a biological characteristic is much reflected, and may be called an artificial neural network in models in which a biological characteristic is less reflected.

### Artificial Neural Network Configuration Information

Herein, artificial neural network configuration information may denote data representing a configuration of an artificial neural network. The configuration of an artificial neural network may include, for example, the kinds and number of neural network layers, the characteristic and number of neurons configuring a neural network layer, a connection structure and characteristic between neural network layers, and a connection structure and characteristic between neurons.

### Intermediate Representation

Herein, artificial neural network intermediate representation may be defined as a data structure or code which is internally used by a compiler or a virtual machine so as to represent a source code representing an artificial neural network.

### Graph

Herein, a graph may be used as a concept which includes nodes configuring an artificial neural network and edges connecting the nodes with each other.

### Partitioning

Herein, partitioning may denote an operation of partitioning a certain graph into partial graphs. The partial graphs obtained through partitioning should derive a before-partitioning graph when the partial graphs are summated.

### Partitioning Space

Herein, a partition space may denote a set of the number of cases of a partitioning method capable of being used in a process of partitioning the graph into the partial graphs.

### Partitioning Space Search

Herein, partitioning space search may denote an operation of searching for a partitioning space.

### Objective Function

Herein, an objective function may be the term which is generally used in optimization theory. The optimization theory may denote a mathematical method which calculates a value of a variable for minimizing or maximizing a certain objective function.

### Objective Function for Partitioning

Herein, an objective function for partitioning may denote an objective function which is used for optimizing a module or function of performing partitioning through partitioning space search.

### Resource

Herein, a resource may include all concepts which may be considered to be a temporal and spatial resource, a power and electricity resource, a device resource (calculation, storage, connection information transfer, etc.), a profile or data resource.

### Embedding

Herein, embedding may denote a process of converting raw data into a numerical vector or a result thereof.

### Self-Attention (SA)

Herein, self-attention (SA) may be a technique which detects a correlation between elements configuring a vector and re-represents a vector, based on the correlation. When there is a certain vector “x=[x₁, x₂, xₙ]^{T}” where a length is n which is a positive integer, SA may calculate three different vectors “Q=x*W_{Q}, K=x*W_{K}, and V=x*W_{V}” from x. Here, * may represent a matrix multiplication, and a matrix “W_{Q}, W_{K}, and W_{V}” may be a parameter matrix which is learned through gradient descent and may have the same dimension (for example, 1 by m, on m which is a positive integer). SA may calculate Q, K, and V and may then perform score function calculation where Q and K are inputs. A score function may be various in kind and may include, for example, dot, scaled dot, general, concat, and location-base score functions. A score calculated by SA may be represented by a matrix having an n by n form (for example, Q*K^{T}). Such a matrix may represent a correlation between elements which configure x and is changed in meaning, based on a meaning of each of W_{Q}, W_{K}, and a score function. SA may perform softmax on each row configuring a correlation matrix and may a matrix multiplication “*” on a result thereof and V to obtain an n by m matrix. The n by m matrix derived by SA may denote that elements configuring x are re-represented and collected in m dimension, and a detailed meaning thereof may be changed based on a score function used and a direction for learning W_{Q}, W_{K}, and W_{V}. SA may be applied even when elements configuring x are represented in multi-dimension (for example, one dimension on 1 which is a positive integer of 1 or more), and in this case, W_{Q}, W_{K}, and W_{V} may be configured with 1 by m.

### Masked Self Attention (MSA)

Herein, MSA may be used when specific elements configuring x do not clearly have a correlation in all directions or when a user of SA intentionally desires to exclude a correlation between specific elements. MSA may additionally perform a process of overlaying a −inf value on a correlation which is to be excluded, in an n by n matrix obtained from a score function of SA.

### Multi-Head Masked Self Attention (MMSA)

Herein, MMSA may denote that MSA is performed in parallel a plurality of times. That is, MMSA may denote that h number of different matrixes [W_{Q}, W_{K}, W_{V}] are used on h which is a positive integer. A result of MMSA may be a form where h number of matrixes (size: n by m) obtained from each MSA are connected with one another, and thus, may be a matrix which has a n by mh size as a result.

### Artificial Neural Network Compiler

Herein, an artificial neural network compiler may extract, convert, generate, or provide information, needed for computing hardware equipping and driving, from an artificial neural network when an artificial neural network is equipped (disposed or loaded) in computing hardware configured with various logic chips (for example, central processing unit (CPU), graphics processing unit (GPU), neural processing unit (NPU), neural management unit (NMU), and processing in memory (PIM)) and learning or inference desired by the artificial neural network is to be performed.

A function provided by the artificial neural network compiler may include artificial neural network intermediate representation based on a computing hardware characteristic, artificial neural network intermediate representation arrangement, and computing hardware operation code generation.

Therefore, a condition which should be considered in a case where the artificial neural network compiler is designed may include a good method for re-representing (artificial neural network intermediate representation) an artificial neural network in a case which desires to efficiently operate the artificial neural network in computing hardware, a good method for arranging a re-represented artificial neural network in computing hardware, and a method which designs a source code which is to be used in operating the artificial neural network in computing hardware.

The present invention may include an apparatus and technology for optimally providing artificial neural network intermediate representation information among functions provided by the artificial neural network compiler. The apparatus and technology may include an apparatus and technology which may provide artificial neural network intermediate representation while optimizing resource use occurring when an artificial neural network is equipped in computing hardware and used.

The present invention may have the following differences with the related art.

Node scoring (or embedding) described below and probabilistic technology based thereon may be used in minimizing a partitioning space.

Conventional technologies may use node scoring for partitioning space search. Such a method may have a problem where a possibility that an optimal partitioning method is not found is high because a size of a partitioning space exponentially increases in a case where a size of an artificial neural network increases.

Information associated with partitioning objective functions may be used as inputs of an artificial neural network partitioning module, a partitioning function, a partitioning space minimization module, a node scoring function, and probabilistic functions based thereon.

Conventional technologies perform artificial neural network partitioning or scoring (or embedding) by using only graph information as an input, and due to this, may not reflect a result which is changed based the kind and combination of partitioning objective functions and a weight variation between the partitioning objecting functions.

Before describing in detail the present invention, the present invention will be described under the following assumption.

In the present invention, a process, an apparatus, or technology which adds or excludes an element of an artificial neural network for learning, lightness, or the other purpose may deviated from the scope of the present invention, and thus, it may be assumed that occurs, have occurred, or may occur in a process, technology, or apparatus operation described in the present invention, and descriptions relevant thereto may be omitted.

In a case where an artificial neural network is considered to be a graph, a node in a graph may include all conceptual and physical elements associated with a neuron or a partial element configuring the neuron, an arithmetic operation performed by the neuron, or information transfer.

In a case where an artificial neural network is considered to be a graph, an inter-node connection in a graph may include all conceptual and physical elements which connect the inside and the outside of a node or are used information transfer therebetween.

It may be assumed that ‘artificial neural network configuration information’, ‘computing hardware feature’, ‘partitioning objective function’, ‘priorities or weights of partitioning objective functions’, ‘information about partial graphs’, or ‘the other desired information’, which is used as an input by the artificial neural network compiler or modules configuring the same, is converted into a vector or a matrix form including a digit so that the artificial neural network compiler or the modules configuring the same may directly use in calculation.

It may be assumed that a special value for differentiating pieces of information is inserted between pieces of information used as an input in multi-head masked self-attention.

An operation or function based on a multi-head masked attention mechanism may denote learning or operation capable of all learning, which may use a multi-head masked self-attention result. For example, there may be a matrix operation, matrix conversion, a normalization function, an artificial neural network function, a probability process, a linear recursion function, and attention.

It may be assumed that mask information about pieces of information provided as an input to multi-head masked self-attention is clearly assigned from input information, and mask information may be omitted in the following description and drawings.

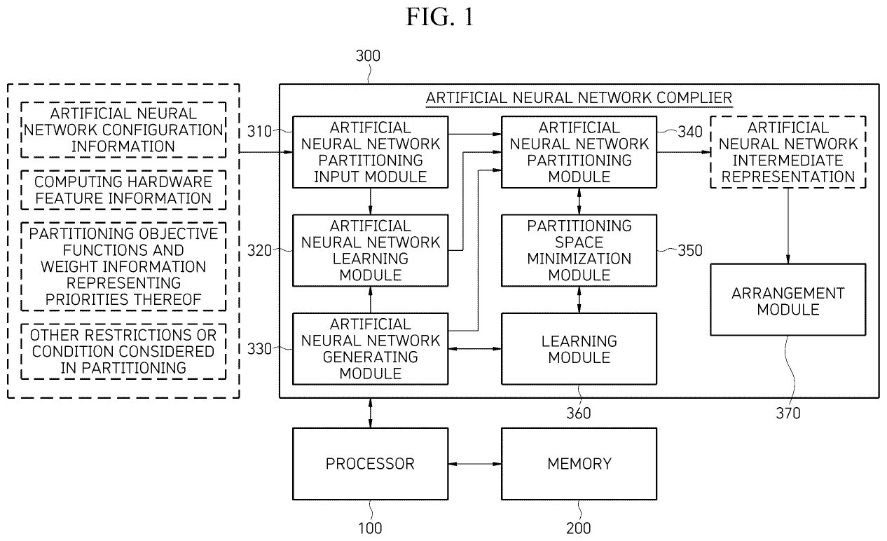

FIG. 1 is a configuration diagram of a computing device including an artificial neural network compiler according to an embodiment of the present invention.

Referring to FIG. 1, the computing device according to an embodiment of the present invention may include a processor 100, a memory 200, and an artificial neural network compiler 300.

The processor 100 may be a logic device which controls and manages an overall operation of the computing device according to an embodiment of the present invention, and for example, may be implemented as a logic chip which controls an operation and/or execution of the artificial neural network complier 300. The logic chip may include, for example, a CPU, a GPU, an NPU, a PIM, and a mobile application processor (AP).

The memory 200 may include a volatile and/or non-volatile memory which stores instructions needed for the operation and/or execution of the artificial neural network complier 300 and may transfer the stored instruction to the processor 100, based on a request of the processor 100. Also, the memory 200 may temporarily and/or permanently store intermediate data and result data generated by the processor 100 and the artificial neural network complier 300.

The artificial neural network complier 300 may output artificial neural network intermediate representation which is optimized to efficiently use a computing hardware resource by using, as inputs, artificial neural network configuration information, computing hardware feature information, partitioning objective functions and weight information representing priorities thereof, and the other restrictions or condition which should be considered in a process of partitioning the artificial neural network, based on control by the processor 100.

To this end, the artificial neural network complier 300 may include an artificial neural network partitioning input module 310, an artificial neural network learning module 320, an artificial neural network generating module 330, an artificial neural network partitioning module 340, a partitioning space minimization module 350, a learning module 360, and an arrangement module 370.

The artificial neural network partitioning input module 310 may be an element which transfers, to a peripheral module, at least one of artificial neural network configuration information, computing hardware feature information, partitioning objective functions and weight information representing priorities thereof, and the other restrictions or condition which should be considered in a process of partitioning the artificial neural network, based on control by the processor 100 and may be a kind of buffer memory.

The artificial neural network configuration information may include, for example, pieces of information associated with the kinds and number of neural network layers configuring an artificial neural network, the characteristic and number of neurons configuring the neural network layer, a connection structure between the neural network layers, and a connection structure and characteristic between neurons.

The computing hardware feature information may include, for example, information (for example, the kind of operation supported, the number of operations capable of allocation, and overall information such as operation or power efficiency profile) about logic devices included in computing hardware, information (for example, connection interface information and overall information such as transferred/received signal or data profile) about a connection between logic devices, and information (for example, connection interface information and overall information such as transferred/received signal or data profile) about a connection between each logic device and a memory device. Furthermore, the computing hardware feature information may include all pieces of computing hardware information which may be considered in a partitioning process of an artificial neural network described below.

The partitioning objective function may be associated with computing hardware characteristics in a partitioning process of an artificial neural network which is performed by the artificial neural network partitioning input module 310 and will be described below, and may include all functions which may re-represent an artificial neural network to pursue a certain kind of gain capable of being obtained when being driven on computing hardware. The partitioning objective function may be, for example, a function which is defined in optimization theory so as to determine the partitioning method for minimizing the amount of memory use, an execution time, and the amount of power use of the artificial neural network. Furthermore, the partitioning objective function may include all kinds of functions associated with resource use amount optimization, resource use amount distribution optimization, and additional influence mitigation caused by resource use, which may occur in the computing hardware.

The artificial neural network learning module 320 may be a module which teaches an artificial neural network generated by the artificial neural network generating module 330 and may teach the artificial neural network through plasticity or modifications thereof, a gradient descent method, and modifications thereof, which depend on information transfer signal occurrence timing or frequency between neurons.

The artificial neural network generating module 330 may be a module which generates an artificial neural network (an artificial neural network model or artificial neural network configuration information) and may generate artificial neural network configuration information to transfer to a peripheral module, based on a known random method or method which replicates an artificial neural network model.

The artificial neural network partitioning module 340 may partition a graph, representing an artificial neural network, into partial graphs by using artificial neural network configuration information as an input. The artificial neural network partitioning module 340 may perform partitioning to have a functional function where the graph is equal or similar to the partial graph, based on the artificial neural network and a computing hardware characteristic.

In an embodiment, the artificial neural network partitioning module 340 may partition (re-represent) the artificial neural network configuration information, based on a computing hardware feature where the partitioning objective function and a resource are defined by an equation. Here, as described above, the partitioning objective function may be a function for determining a method of partitioning the artificial neural network configuration information so as to minimize the amount of memory use, minimize an execution time, and minimize the amount of power use.

In an embodiment, the artificial neural network configuration information used as an input by the artificial neural network partitioning module 340 may include artificial neural network configuration information corresponding to source information input through the artificial neural network partitioning input module 310, configuration information about an artificial neural network generated by the artificial neural network generating module 330, and configuration information about an artificial neural network learned by the artificial neural network learning module 320.

In an embodiment, the artificial neural network partitioning module 340 may partition the graph into the partial graphs by using an optimal partitioning method selected by configuring and searching for the partitioning space, based on node information input from the partitioning space minimization module 350 described below. Subsequently, the artificial neural network partitioning module 340 may generate artificial neural network intermediate representations, based on the partial graphs.

The partitioning space minimization module 350 may be a lower module of the artificial neural network partitioning module 340 and may provide the node information to the artificial neural network partitioning module 340.

In an embodiment, in a case where the partitioning space minimization module 350 defines, as a total partitioning space, a set including the number of all cases corresponding to a partitioning method capable of being used in a process of partitioning the graph into the partial graphs, the partitioning space minimization module 350 may determine a partial partitioning space which should be intensively searched for in the total partitioning space and may then generate the node information about nodes associated with the partial partitioning space.

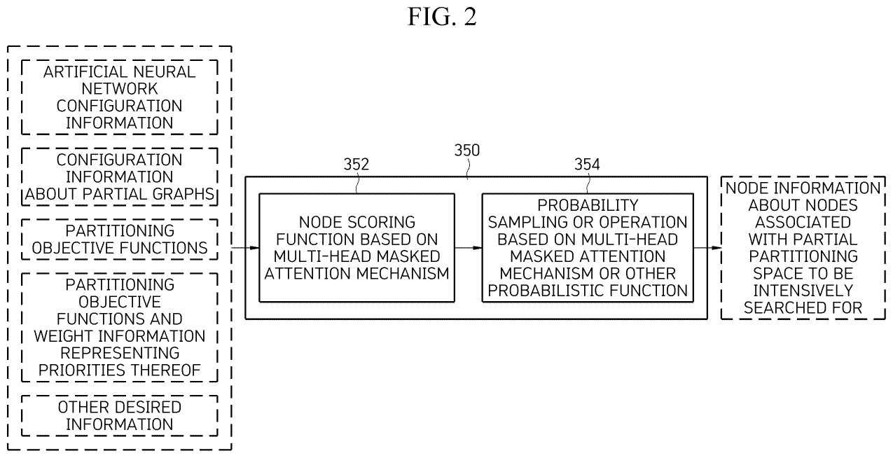

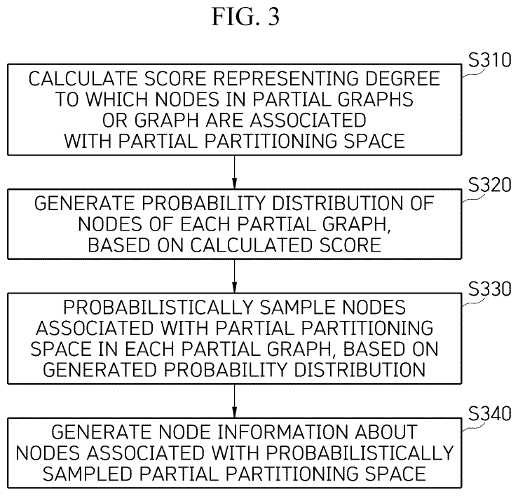

The partitioning space minimization module 350 may be implemented with, for example, functions capable of minimization through learning. The partitioning space minimization module 350 will be described in detail with reference to FIGS. 2 and 3.

The learning module 360 may be a module for optimizing the partitioning space minimization module 350 through learning.

The arrangement module 370 may be a module which arranges (install or load) the artificial neural network intermediate representations, generated by the artificial neural network partitioning module 340, in different computing hardware resources (for example, CPU, GPU, NPU, and PIM).

FIG. 2 is a configuration diagram illustrating an example of the partitioning space minimization module 350 of FIG. 1.

Referring to FIG. 2, in a case where the partitioning space minimization module 350 defines, as a total partitioning space, a set including the number of all cases corresponding to a partitioning method capable of being used in a process of partitioning the graph into the partial graphs, the partitioning space minimization module 350 may determine a partial partitioning space which should be intensively searched for in the total partitioning space and may then generate node information about nodes associated with the partial partitioning space. The node information, as described above, may be used as information for configuring a partitioning space which is to be searched for by the partitioning module in a case where the artificial neural network partitioning module 340 partitions an artificial neural network.

To generate the node information, in an embodiment, the partitioning space minimization module 350 may include a partitioning space minimization function, and the partitioning space minimization function may include, for example, a node scoring function 352 based on a multi-head masked attention mechanism and a probability sampling function 354.

In an embodiment, the node scoring function 352 based on the multi-head masked attention mechanism may calculate a score representing the degree to which nodes in the partial graphs or the graph are associated with the partial partitioning space which should be intensively searched for.

In an embodiment, the probability sampling function 354 may generate a probability distribution of the nodes, based on the score, may sample the nodes, based on the probability distribution, and may generate the node information, based on the probability sampling.

In an embodiment, the partitioning space minimization function may further include a function which performs an attention mechanism-based matrix operation for generating node information about nodes associated with the partial partitioning space which should be intensively searched for, based on the score in addition to the probability sampling function 354.

In an embodiment, the partitioning space minimization function may further include a probabilistic function for generating information about the nodes associated with the partial partitioning space which should be intensively searched for, based on the score in addition to the probability sampling function 354.

In an embodiment, the probabilistic function may include, for example, a probabilistic filtering function and a probabilistic outlier search function.

A value of each of a parameter and a hyper parameter, which are used by the node scoring (or embedding) function included in the partitioning space minimization function, the probability sampling function, the attention mechanism-based matrix operation, and the other probabilistic function may be changed through learning.

The node scoring function 352, the probability sampling function 354, the function which performs the attention mechanism-based matrix operation, and the other probabilistic functions may be stored based on the kind of artificial neural network, a partitioning objective function, and a computing hardware characteristic so as to be reused in another compile time or hardware runtime.

FIG. 3 is a flowchart for describing a process of generating node information about nodes for participating in a partitioning space in nodes of each partial graph in the partitioning space minimization module of FIG. 2.

Referring to FIG. 3, first, in step S310, a process of calculating a score representing the degree to which nodes in the partial graphs or the graph are associated with the partial partitioning space which should be intensively searched for may be performed by the node scoring function 352 based on a multi-head masked attention mechanism of FIG. 2 may be performed.

Subsequently, in step S320, a process of generating a probability distribution of the nodes of each of the partial graphs, based on the calculated score, may be performed by the probability sampling function 354 of FIG. 2.

Subsequently, in step S330, a process of probabilistically sampling nodes associated with the partial partitioning space in each of the partial graphs, based on the generated probability distribution, may be performed by the probability sampling function 354 of FIG. 2.

Subsequently, in step S340, a process of generating the node information about the nodes associated with the probabilistically sampled partial partitioning space may be performed in the probability sampling function 354 of FIG. 2. The node information generated in this manner may be input to the artificial neural network partitioning module 340, and the artificial neural network partitioning module 340 may use the node information as information for partitioning an artificial neural network.

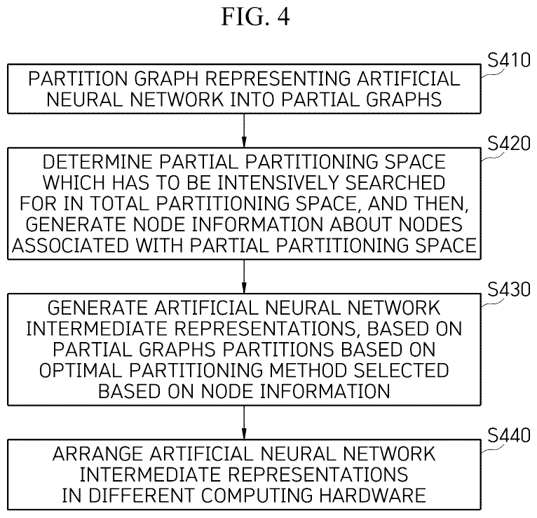

FIG. 4 is a flowchart for describing a method of compiling an artificial neural network according to an embodiment of the present invention.

Referring to FIG. 4, first, in step S410, a process of partitioning a graph representing an artificial neural network into partial graphs by using the artificial neural network partitioning module 340 may be performed.

Subsequently, in step S420, in a case where the partitioning space minimization module 350 defines, as a total partitioning space, a set including the number of all cases corresponding to a partitioning method capable of being used in a process of partitioning the graph into the partial graphs, the partitioning space minimization module 350 may perform a process of determining a partial partitioning space which should be intensively searched for in the total partitioning space, and then, generating node information about nodes associated with the partial partitioning space.

Subsequently, in step S430, the artificial neural network partitioning module 340 may perform a process of again partitioning the graph into the partial graphs by using an optimal partitioning method selected by configuring and searching for the partial partitioning space, based on the node information, and generating and outputting artificial neural network intermediate representation, based on the partial graphs.

Subsequently, in step S440, a process of arranging the artificial neural network intermediate representation in different computing hardware may be performed in the arrangement module 370.

In an embodiment, step S420 of generating the node information associated with the partial partitioning space which should be intensively searched for may include a process of probabilistically extracting nodes associated with a partial partitioning space which should be intensively searched for in nodes in the partial graphs or the graph, based on a partitioning space minimization function, and a process of generating the node information about the probabilistically extracted nodes.

In an embodiment, the partitioning space minimization function may include a node scoring function based on a multi-head masked attention mechanism, which calculates a score representing the degree to which nodes in the partial graphs or the graph are associated with the partial partitioning space which should be intensively searched for.

In an embodiment, the partitioning space minimization function may include a probability sampling function for determining the partial partitioning space which should be intensively searched for, based on the score.

In an embodiment, the partitioning space minimization function may include a function which performs an attention mechanism-based matrix operation for determining the partial partitioning space which should be intensively searched for, based on the score.

In an embodiment, the partitioning space minimization function may further include a probabilistic function for determining the partial partitioning space which should be intensively searched for, based on the score.

In an embodiment, the probabilistic function may include a probabilistic filtering function and a probabilistic outlier search function.

In an embodiment, step S420 of generating the node information about nodes associated with the partial partitioning space which should be intensively searched for may include a process of calculating a score representing the degree to which nodes in the partial graphs or the graph are associated with the partial partitioning space which should be intensively searched for, based on the node scoring function based on the multi-head masked attention mechanism, a process of generating a probability distribution of the nodes of the graph or the partial graph, based on the calculated score, a process of probabilistically sampling nodes associated with the partial partitioning space which should be intensively searched for, based on the generated probability distribution, and a process of generating the node information about the nodes associated with the probabilistically sampled partial partitioning space.

In an embodiment, step S430 of generating the artificial neural network intermediate representations may include a process of partitioning the graph into the partial graphs by using an optimal partitioning method, based on a partitioning objective function and a computing hardware characteristic.

In an embodiment, the partitioning objective function may be a function which is defined in optimization theory so as to determine the partitioning method for minimizing the amount of memory use, an execution time, and the amount of power use of the artificial neural network.

In an embodiment, the computing hardware characteristic may include information about logic devices included in computing hardware and connection information between the logic devices.

In an embodiment, the information about the logic devices may include the kind of operation, the number of operations capable of being allocated to each logic device, and a power efficiency profile of each logic device.

In an embodiment, the connection information between the logic devices may include interface information between the logic devices and a data profile transferred or received between the logic devices.

According to the embodiments of the present invention, the artificial neural network compiler may provide artificial neural network intermediate representation optimized to efficiently use a computing hardware resource and may equip the optimized artificial neural network intermediate representation in the computing hardware, and thus, may efficiently use resources of the computing hardware.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A method of compiling an artificial neural network, the method comprising:
a step of partitioning a graph representing an artificial neural network into partial graphs by using an artificial neural network partitioning module;
a step of determining, by using a partitioning space minimization module, a partial partitioning space which has to be intensively searched for in a total partitioning space and then generating node information about nodes associated with the partial partitioning space, in a case which defines, as the total partitioning space, a set including the number of all cases corresponding to a partitioning method capable of being used in a process of partitioning the graph into the partial graphs;
a step of partitioning, by using the artificial neural network partitioning module, the graph into the partial graphs by using an optimal partitioning method selected by configuring and searching for the partial partitioning space, based on the node information, and generating artificial neural network intermediate representations, based on the partial graphs; and
a step of arranging the artificial neural network in different computing hardware resources by using an arrangement module, based on the artificial neural network intermediate representations.

2. The method of claim 1, wherein the step of generating the node information comprises:
a step of probabilistically extracting nodes associated with the partitioning space in nodes of the partial graphs or the graph by using a partitioning space minimization function; and
a step of generating the node information about the probabilistically extracted nodes.

3. The method of claim 2, wherein the partitioning space minimization function comprises a node scoring function based on a multi-head masked attention mechanism, which calculates a score representing the degree to which the nodes of the partial graphs or the graph are associated with the partial partitioning space.

4. The method of claim 3, wherein the partitioning space minimization function further comprises a probability sampling function for determining the partial partitioning space, based on the score.

5. The method of claim 3, wherein the partitioning space minimization function further comprises a function of performing an attention mechanism-based matrix operation for determining the partial partitioning space, based on the score.

6. The method of claim 3, wherein the partitioning space minimization function comprises a probabilistic function for determining the partial partitioning space, based on the score.

7. The method of claim 6, wherein the probabilistic function comprises a probabilistic filtering function and a probabilistic outlier search function.

8. The method of claim 1, wherein the step of generating the node information comprises:
a step of calculating a score representing the degree to which nodes of the partial graphs or the graph are associated with the partial partitioning space, based on a node scoring function based on a multi-head masked attention mechanism;
a step of generating a probability distribution of the nodes of the graph or the partial graph, based on the calculated score;
a step of probabilistically sampling nodes associated with the partial partitioning space, based on the generated probability distribution; and
a step of generating the node information about the probabilistically sampled nodes.

9. The method of claim 1, wherein the step of generating the artificial neural network intermediate representations comprises a step of partitioning the graph into the partial graphs by using an optimal partitioning method, based on a partitioning objective function and a computing hardware characteristic.

10. The method of claim 9, wherein the partitioning objective function is a function which is defined in optimization theory so as to determine the partitioning method for minimizing the amount of memory use, an execution time, and the amount of power use of the artificial neural network.

11. The method of claim 9, wherein the computing hardware characteristic comprises information about logic devices included in computing hardware and connection information between the logic devices.

12. The method of claim 11, wherein the information about the logic devices comprises the kind of operation, the number of operations capable of being allocated to each logic device, and a power efficiency profile of each logic device.

13. The method of claim 11, wherein the connection information between the logic devices comprises interface information between the logic devices and a data profile transferred or received between the logic devices.
